(19) United States
(12) Patent Application Publication
(10) Pub. No.: US 2024/0337481 A1
(43) Pub. Date: Oct. 10, 2024

(54) Method for optical measurement of a thread on an end of a metal pipe or on a sleeve

(71) Applicant: SMS group GmbH, Düsseldorf (DE)

(72) Inventors: Martin SAUERLAND, Niederkrüchten (DE); Jochen SCHMITZ, Wassenberg (DE); Michael HÖFER, 41372 Niederkrüchten (DE)

(73) Assignee: SMS group GmbH, Düsseldorf (DE)

(21) Appl. No.: 18/293,558

(22) PCT Filed: Jul. 8, 2022
(86) PCT No.: PCT/EP2022/069127

§ 371 Date: Jan. 30, 2024

(30) Foreign Application Priority Data
Aug. 3, 2021 (DE) 10 2021 208 378.1

(51) Int. Cl. G01B 11/24

(52) U.S. Cl. CPC G01B 11/2425; G01B 2210/50

(57) ABSTRACT

An arrangement (1) and a method for optical measurement of a thread, in particular for measurement of an internal thread (12) on a sleeve or on a sleeve end of a metal pipe (11), are disclosed. The arrangement (1) comprises at least one optical sensor (5), at least one further optical element that can be adjusted relative to the optical sensor (5) and that is arranged on an optical bench (3) at a determined distance from the sensor along an optical axis (7) and is designed for optically scanning the internal thread (12), as well as means for acquiring and/or storing and/or evaluating the measurement data recorded by the sensor.

### CROSS-REFERENCE TO RELATED APPLICATION

This application is a national stage application, filed under 35 U.S.C. § 371, of International Patent Application PCT/EP2022/069127, filed on Jul. 8, 2022, which claims the benefit of German Patent Application DE 10 2021 208 378.1, filed on Aug. 3, 2021.

### TECHNICAL FIELD

The disclosure relates to an arrangement for the optical measurement of a thread, in particular for the measurement of an internal thread on a sleeve end of a metal pipe or on a sleeve. The disclosure also relates to a method for optical measurement of a thread, in particular for measuring an internal thread on a sleeve end of a metal pipe or in a sleeve.

### BACKGROUND

Pipes that are used to transport pressurized fluids, such as natural gas or crude oil, and that are bolted together in a pressure-resistant, gas-tight and liquid-tight manner, are subject to stringent requirements for leak-tightness. With such OCTG pipes as casing pipes or riser pipes for oil or gas exploration wells or natural gas or oil production pipelines, conical threads with undercut thread flanks are typically used. A sealing lip is usually attached to the threads on the front side of the pipe. Both the thread and the sealing lip must meet the highest precision requirements. In the prior art, in principle it is known to optically measure the threads for quality control of the pipes.

A method and a device for optically measuring the external thread profile of pipes is known, for example, from WO 2019/09371 A1.

WO 2012/069154 A1 discloses a method and a device for inspecting the external thread of an oilfield pipe, which comprises a sensor guided on a frame, wherein the sensor is arranged on a carrier provided with threads, the thread of which is designed in accordance with the thread of the pipe and which surrounds a part of the conical thread of the pipe to be inspected. The sensor is designed as a confocal sensor.

A device for measuring threads on oil field pipes is also known from WO 2020/232041 A1. The device comprises a sensor unit that is designed to measure a distance between the sensor and a part of the thread of the metal pipe. The sensor/the sensor unit can be adjusted radially and axially with respect to the internal thread of the metal pipe using a large number of actuators, wherein a control device can generate a three-dimensional image of the internal thread from a large number of distance measurements. The sensor unit comprises a confocal chromatic sensor, which is moved into the metal pipe on a linkage and centered inside the metal pipe by means of sensing rollers. After concentric alignment of the guide rod of the linkage, the sensor is adjusted both translationally and rotationally within the metal pipe, wherein the thread is scanned and a three-dimensional image of the thread is generated by means of the measurement data obtained in this manner.

The arrangement known from WO 2020/232041 A1 is not readily suitable for pipes with a small internal diameter. The tactile centering of the measuring arrangement is complex and requires a relatively large amount of installation space. The field of view of the sensor is aligned at a predetermined angle to the longitudinal axis of the metal pipe and the rod to which the sensor is fastened can be actuated by means of three different actuators, wherein one actuator is provided for the rotational movement of the rod about its own longitudinal axis, one actuator for a rotational movement of the rod about the longitudinal axis of the metal pipe and one actuator for a linear movement of the rod within the metal pipe, i.e. parallel to the longitudinal axis of the metal pipe. With this arrangement, the scanning of undercut and/or conical threads is difficult. It can be assumed that the complete acquisition of all distance information for mapping the thread requires a relatively long measuring time.

### SUMMARY

The disclosure provides an arrangement and a method of the type mentioned at the beginning, which enable optical measurement, in particular of undercut and/or conical internal threads on sleeves of oil field pipes, with a relatively short measuring time.

According to one aspect, an arrangement is provided for optical measurement of a thread on an end of a metal pipe, in particular for measuring an internal thread on a sleeve end of a metal pipe or on a sleeve, comprising at least one optical sensor, at least one further optical element that can be adjusted relative to the optical sensor and that is arranged on an optical bench at a determined distance from the sensor along an optical axis and is designed for optically scanning the internal thread, and further comprising means for acquiring and/or storing and/or evaluating the measurement data recorded by the sensor.

By combining the sensor with at least one further optical element, small sensors with an angled or straight design can be used. It is particularly advantageous if a single sensor is provided in a straight design, which can be aligned along the optical axis of the system, for example. The sensor and the further optical element form a system.

With an advantageous variant of the arrangement, it is provided that the optical bench and/or the frame can be adjusted at least linearly in the longitudinal axis or parallel to a longitudinal axis of the metal pipe.

The sensor can, for example, be designed as a confocal sensor, in particular as a confocal chromatic sensor. Such sensors are small. By combining it with a further optical element, this sensor can be designed in a straight design, for example, as a result of which the arrangement is compact and also allows internal threads with a small internal diameter to be measured.

The sensor can be designed as a confocal displacement sensor, for example. With a confocal chromatic measuring system, white light is broken down into its partial wavelengths via a lens system, in such a way that each wavelength focuses at a different defined distance. Blue wave trains are focused close to the sensor, red ones further away from the sensor. The reflected light is collected and analyzed interferometrically. The color of the highest intensity corresponds to the respective focus and thus the distance of the sensor to the measuring point. By acquiring a large number of points/distances, a thread profile of the thread to be measured can be generated in a simple manner. Such a thread profile can be acquired and shown in two or three dimensions.

With an advantageous variant of the arrangement, it is provided that the optical element comprises a mirror that is adjustable about at least one axis.

With the arrangement, it can be provided that the optical element comprises at least one, preferably two, actuators with which the mirror, in each case, can be pivoted about one or other axis. For example, the mirror can be double cardanically suspended, wherein the cardan frames are in each case adjustable by means of magnetic actuators.

With a particularly preferred variant of the arrangement, the optical element is designed as a so-called “galvo scanner,” the mirror of which is designed to be rotatable and pivotable relative to the optical axis, such that at least a partial circumference of the internal thread of the metal pipe can be optically scanned. The signal acquired by the mirror of the optical element is transmitted to the sensor along the optical axis of the arrangement.

The sensor expediently comprises a lens system and a control device that evaluates the signals from the lens system interferometrically. For example, the sensor can be connected to the control device by means of suitable cabling, such as a fiber optic cable.

Expediently, the optical bench and/or the frame can be adjusted by means of at least one linear drive.

The arrangement can further comprise means for centering the optical bench within the metal pipe, which operate without contact. The signal acquisition and signal processing can be effected both in a single-channel or multi-channel manner.

If the arrangement comprises at least one sensor angled by 90°, an internal centering of the arrangement within the metal pipe can be achieved by means of such sensor.

A further aspect of the disclosure relates to a method for optical measurement of a thread on one end of a metal pipe, in particular a method for measuring an internal thread on a sleeve end of a metal pipe or on a sleeve, wherein the method comprises the following steps:
A) Providing an optical system with at least one optical sensor and at least one further optical element, which are arranged along an optical axis at a determined distance relative to one another,
B) Adjusting the optical system in the longitudinal axis of the metal pipe or parallel to the longitudinal axis of the metal pipe, preferably within the metal pipe, or adjusting the metal pipe relative to the stationary system in the longitudinal axis or parallel to the longitudinal axis of the metal pipe, and
C) Scanning of the internal thread during a linear adjustment of the optical system and/or during a rotation of the optical element at an angle to the optical axis, and
D) Acquiring and/or storing and/or processing the measurement values acquired by the sensor.

With the method, two internal threads of a metal pipe or the two opposing internal threads of a sleeve can be measured with a single measurement run.

The thread can be scanned by the sensor over its length and/or over at least a partial circumference, wherein the sensor preferably acquires distance values that are converted into a two-dimensional or three-dimensional measurement image and that are shown accordingly in two or three dimensions.

The optical sensor preferably comprises an optically passive sensor that comprises a lens system and a control device. Preferably, the measurement signals received by the sensor are fed to the control device, which carries out an interferometric evaluation of the measurement signals. The data from the control device can be forwarded via an interface to a computing unit, for example in the form of a computer (PC).

With the method, it is provided that the optical sensor and the further optical element, for example in the form of a mirror, form an optical axis. During a linear adjustment of the optical sensor, for example, the optical element can be adjusted about at least one, preferably two, preferably perpendicularly aligned axes, such that the complete thread can be scanned during a measurement run of the optical system. For this purpose, the optical sensor and the further optical element are preferably arranged in the optical axis so that they can be adjusted relative to one another.

With a preferred variant of the method, the optical system can comprise at least one galvo scanner, which scans at least a partial circumference of the internal thread during a linear adjustment of the optical system.

Thereby, the contour of the threads is preferably acquired and/or shown in two and/or three dimensions.

With a particularly expedient variant of the method, a self-centering of the optical axis of the optical system is provided within the metal pipe or within the sleeve. Upon a measurement run, it can be provided that either the optical system is arranged in a stationary position and the sleeve or the sleeve end is moved over the system or that the metal pipe or the sleeve is arranged in a stationary position and that the measurement sensor/the optical system is adjusted relative to the longitudinal axis of the stationary metal pipe or the stationary sleeve.

With an advantageous and expedient variant of the method, a dark adjustment/dark calibration of the sensor is provided. The dark adjustment can be carried out automatically, for example by moving into a darkened housing.

Furthermore, a sensor calibration can be provided with a reference component that has known dimensions and a known thread profile. Furthermore, contamination of the optical system can also be detected by comparing the light signal strength with stored reference values.

With a particularly advantageous variant of the method, it is provided that the measurement data acquired by the sensor are used to derive control commands for the control and/or regulation of a machine tool, for example a CNC machine, which is designed to produce an internal thread on at least one end of a metal pipe or in a sleeve by machining. The arrangement can, for example, be arranged in a manufacturing line with a thread cutting machine and coupled with the control and regulation device of the thread cutting machine.

Optical control commands can be the following, for example:
Wear detection of the tools and a derived call for a tool change
Readjustment of the tool position, for example in the event of incorrect setting parameters or to compensate for tool wear
Correction of the tools due to geometric arrangement of the cutting inserts (for example, if a step is visible after the tool change)
Correction of tools due to wear (for example, if the cutting inserts start to smear)
Correction of tools due to external influences (for example, if the ambient temperature changes)
Correction of tools due to different blanks (for example, if the material of the pipe is different or the wall thickness is greater or smaller)
Wear detection of tools in order to optimize service life (for example, by coordinating cutting speed, cutting edge geometry, feed rates and measurement results)
Wear detection of tools in order to predict tool breakage
Wear detection of tools to optimize tool inventory
Wear deduction of tools to increase productivity (for example, by replacing tools at an early stage and producing less scrap)
Increase in productivity through cycle time optimization (for example, one can see whether various functions bring the hoped-for added value)
Increase in productivity through improvement of material flow (for example, bottlenecks can be detected earlier at other points and then tools can be changed or cleaning work carried out)
Increase in quality through early problem detection (for example, by measuring specific vibrations in the thread cutting machine and then preventing them in the process, closing the bezel or repeating the finishing cut).
Increase in quality through comparison of the measurement results with the torque on the sleeve screwdriver.
Increase in quality through comparison of the measurement results with the measurement results of other machines (NDT (non-destructive testing): here, magnetic particle testing)

The collected data can also be used for quality evaluation and documentation and for downstream processes and can be correlated with the data from such machines by means of, for example, corresponding control algorithms or AI. Such downstream processes and correlations may be:
Detection of contamination of the sleeve and differentiation from faults
Correlation of the measurement data with previously collected data, for example to detect where stresses in the sleeve, which lead to ovality after thread cutting, come from. Thus, possibly improving the quenching strategy
Increase in quality through comparison of the measurement results with the torque on the sleeve screwdriver
Increase in quality through comparison of the measurement results with the measurement results of other machines (NDT: here, magnetic particle testing)

The measuring device can also have mechanical and/or optical collision protection.

To acquire special thread contour zones (for example, undercut contour), the sensor can be positioned at specific points within the internal thread and a partial region can be scanned with the galvo scanner.

Alternatively or additionally, a multiple movement through the thread with different angles of the light through the galvo mirror (for example, 90° angle, then 100°, then 110° or even 70° or) 80° and a superposition of the curves of the measurement signals can be provided. The aim is to measure each thread contour zone with a sufficiently strong light signal.

Although the disclosure uses the measurement of internal threads as an example, the skilled person will recognize that the arrangement and the method can of course also be provided for the measurement of external threads.

The invention is described below with reference to the accompanying drawings based on an exemplary embodiment.

### BRIEF DESCRIPTION OF THE DRAWINGS

FIG. 1 is a schematic representation of an arrangement for optical measurement of a thread.

FIG. 2 shows the further optical element of the arrangement as a so-called “galvo scanner.”

FIG. 3 is a representation that illustrates the arrangement of the optical element and the sensor relative to one another.

FIG. 4 shows a two-dimensional thread profile created on the basis of the measurement data of the arrangement.

FIG. 5 is a schematic representation of the arrangement in relation to a sleeve end of a metal pipe.

### DETAILED DESCRIPTION

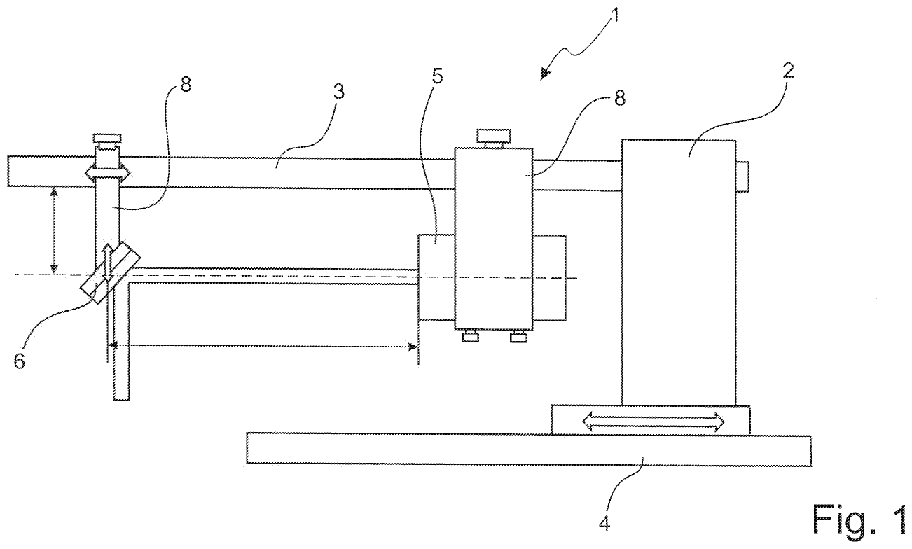

The arrangement 1 shown in FIG. 1 represents a test setup and comprises a frame 2 with an optical bench 3, which is linearly adjustable on a guide rail 4. A chromatic confocal sensor 5 and an optical element in the form of a galvo scanner 6 are arranged along an optical axis 7 on the optical bench 3. The galvo scanner 6 is designed as a mirror 9, which is double cardanically mounted and can be adjusted in cardan elements 10 about two axes aligned perpendicular to one another by means of actuators. The galvo scanner 6 and the optical sensor 5 are in each case adjustable on holders 8 on the optical bench 3. The adjustability of the galvo scanner 6 and the optical sensor 5 is used for the purpose of adjustment. During a measurement run, the distance between the optical sensor 5 and the galvo scanner 6 can be fixed and constant along the optical axis 7. Expediently, both the holder 8 for the galvo scanner 6 and the holder 8 for the optical sensor are vertically adjustable in terms of adjustability perpendicular to the optical axis 7.

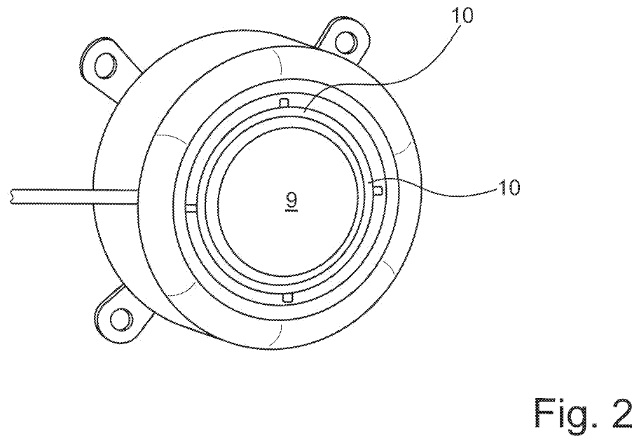

The galvo scanner 6 is schematically shown in FIG. 2, from which it can be seen that it has a circular mirror 9 with a relatively small diameter, which is pivotally mounted in two cardan elements 10.

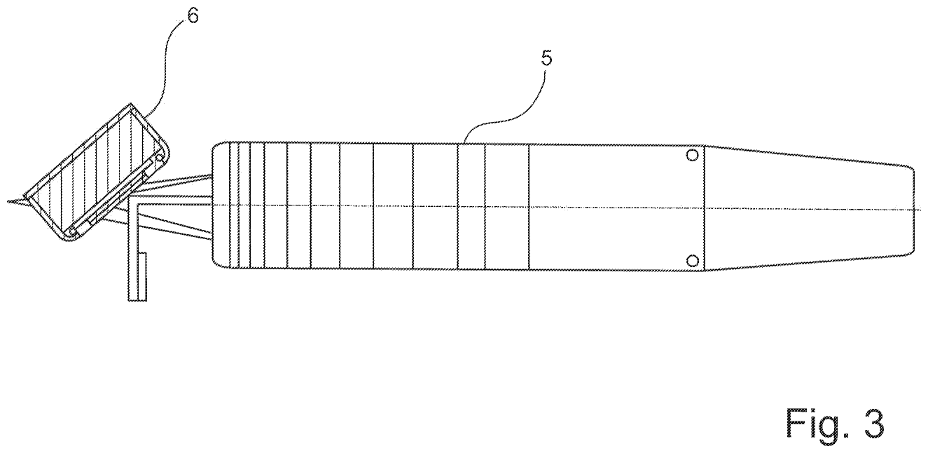

FIG. 3 shows the relative arrangement of the optical sensor 5 and the galvo scanner 6 in the optical axis 7 of the system.

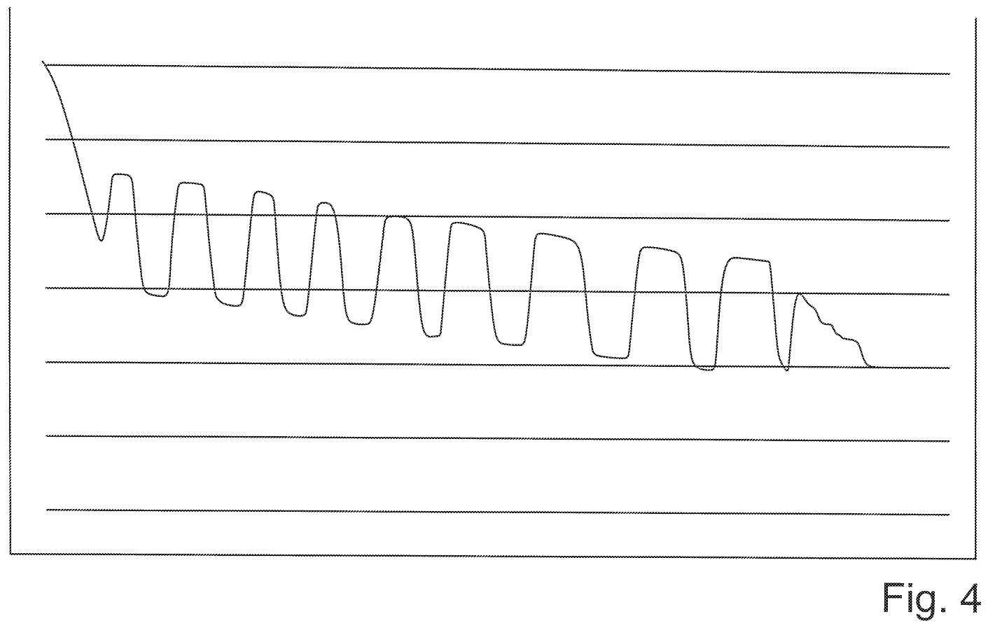

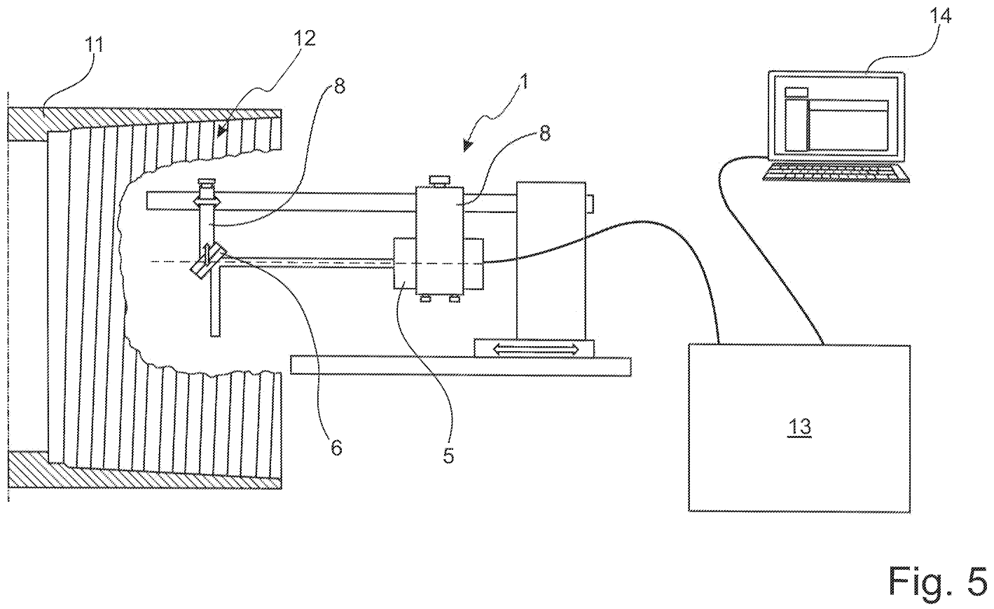

FIG. 4 shows a two-dimensional measurement trace of a recording obtained from a measurement run along the longitudinal axis of a metal pipe 11 (see FIG. 5).

As can be seen from FIG. 5, for example, the metal pipe 11 with an internal thread 12 can be arranged in a stationary position in a measuring stand (not shown), while the optical bench 3 is moved on the guide rail 4 into the interior of the metal pipe 11 and records measurement data of the internal thread 12 during a linear movement of the optical bench 3. The mirror 9 of the galvo scanner can be aligned in each case at a determined angle to the optical axis 7. Alternatively or additionally, the mirror 9 can be adjusted relative to the longitudinal axis of the metal pipe 11 during a measurement run, in order to scan a partial circumference of the internal thread 12.

Although the example described above relates to a metal pipe 11 with one sleeve end, the method can also be carried out on a sleeve with two oppositely arranged internal threads.

It is also readily apparent to the skilled person that the method can also be carried out on an external thread.

As can be seen from the combination of FIGS. 4 and 5, the internal thread 12 is designed as a conical internal thread with undercut thread flanks.

The measurement data acquired by the arrangement 1/by the optical sensor 5 is fed to the control device designated 13, which carries out an interferometric evaluation of the optical signals. The control device 13 forwards the evaluated distance data to software running on a computer 14 for the purpose of showing a two-dimensional or three-dimensional profile. A digital twin of the metal pipe 11 to be measured can be displayed on the computer 14.

### LIST OF REFERENCE SIGNS

1 Arrangement
2 Frame
3 Optical bench
4 Guide rail
5 Optical sensor
6 Galvo scanner
7 Optical axis
8 Holder
9 Mirror
10 Cardan elements
11 Metal pipes
12 Internal thread
13 Control device
14 Computer

1.-17. (canceled)

18. A method for optical measurement of an internal thread in a sleeve or in a sleeve end of a metal pipe, comprising:
providing an optical system with an optical sensor and a Galvo scanner, which are arranged along an optical axis at a determined distance relative to one another;
adjusting the optical system in a longitudinal axis of the metal pipe or the sleeve or parallel to the longitudinal axis of the metal pipe or the sleeve, or
adjusting the metal pipe or the sleeve relative to the optical system in the longitudinal axis or parallel to the longitudinal axis of the metal pipe or the sleeve while the optical system is stationary;
scanning at least a partial circumference of the internal thread during a linear adjustment of the optical system and/or during a rotation of the Galvo scanner at an angle to the optical axis in a plurality of scans with different angulations of light; and
acquiring, storing, and/or processing measurement signals acquired by the optical sensor; and
superimposing the measurement signals of the plurality of scans.

19. The method according to claim 18, further comprising acquiring and/or showing a contour of the internal thread.

20. The method according to claim 18, further comprising self-centering of the optical axis within the metal pipe or within the sleeve.

21. The method according to claim 18, further comprising dark calibrating the optical sensor.

22. The method according to claim 18, further comprising calibrating the optical sensor with a reference component.

23. The method according to claim 18, further comprising
recognizing contamination by comparing light intensity signals acquired by the optical sensor.

24. The method according to claim 18, further comprising
using the measurement signals acquired by the optical sensor to derive control commands for controlling a machine tool, which is designed to produce an internal thread in an end a metal pipe or in a sleeve by machining.

25. An arrangement for optical measurement of an internal thread in a sleeve end of a metal pipe, comprising
a confocal optical sensor;
a galvo scanner with a mirror that is adjustable about two axes, the galvo scanner being arranged at a determined distance from the confocal optical sensor along an optical axis on an optical bench and designed for optically scanning the internal thread;
means for acquiring and/or storing and/or evaluating measurement signals recorded by the confocal optical sensor; and
a frame that accommodates the optical bench, wherein the optical bench and/or the frame are adjustable at least linearly in or parallel to a longitudinal axis of the metal pipe.
